(19) United States
(12) Patent Application Publication
(10) Pub. No.: US 2006/0113406 A1
(43) Pub. Date: Jun. 1, 2006

(54) Fuel injection valve for internal combustion engines

(76) Inventor: Marco Ganser, Oberageri (CH)

Correspondence Address: HERSHKOVITZ & ASSOCIATES, 1725 I STREET NW, SUITE 300, WASHINGTON, DC, 20006, US

(21) Appl. No.: 11/331,201

(22) Filed: Jan. 13, 2006

Related U.S. Application Data
(63) Continuation of application No. PCT/CH04/00451, filed on Jul. 14, 2004.

(30) Foreign Application Priority Data
Jul. 17, 2003 (CH) 1248/03

(51) Int. Cl. F02M 63/00

(52) U.S. Cl. 239/533.2

(57) ABSTRACT

An injection valve and method of producing it, the injection valve having a lower part of a longitudinal housing embodied as a valve seat element containing a valve seat part. The valve seat part includes a valve seat provided with injection openings, and is embodied as a nozzle body which is separate from the valve seat element and connected to the same. An injection valve member is guided in the housing in a longitudinally displaceable manner and co-operates with the valve seat in order to close and open the injection openings. The outer side of the valve seat part is provided with a seat surface formed by the envelope surface of a circular cone. The seat surface is used to position the valve seat part on a bearing surface on the valve seat element, also formed by the envelope surface of a circular cone. The half opening angles of the circular cones fixing the seat surface and the bearing surface are selected in such a way that the nozzle bodies are held in the valve seat element in a self-locking and sealing manner.

### CROSS-REFERENCE TO RELATED APPLICATIONS

The present application is a continuation application of International Application PCT/CH2004/000451 filed on Jul. 14, 2004, which, in turn, is based on Swiss Patent Application No. 1248/03, filed on Jul. 17, 2003, the disclosures of which are expressly incorporated by reference herein in their entireties.

### BACKGROUND OF THE INVENTION

1. Field of the Invention

The present invention relates to a fuel injection valve for the intermittent injection of fuel into the combustion space of internal combustion engines.

2. Discussion of Background Information

In a fuel injection valve, such as is known, for example, from WO-A-02/086309, it may happen that, because of a failure, the injection valve member remains in the open position for longer than is necessary for a full-load injection operation. The result of this is that the corresponding cylinder combustion space is supplied with an excess of fuel, which may cause damage to the engine.

To avoid such damage, then, it is known, in fuel injection systems in which the individual fuel injection valves are supplied with fuel from a high-pressure fuel store (accumulator or common rail), to arrange, in the supply lines to the fuel injection valves, valves for limiting the throughflow quantity (see, for example, DE-A-43 44 190; DE-A-22 07 643; U.S. Pat. No. 4,589,393). These throughflow-quantity limiting valves shut off the throughflow of fuel in the event of an operating fault in the fuel injection valves.

These known solutions are complicated and costly, since, on the one hand, such a throughflow-quantity limiting valve has to be provided in each supply line to the fuel injection valves, and, on the other hand, the housing parts of these valves and the screw connections belonging to them have to be designed for the very high operating pressure (up to 2000 bar). This means, inter alia, that a high outlay is required in order to make the workpieces outwardly leaktight.

In some of the embodiments of fuel injection valves described in the already mentioned WO-A-02/086309, the valve seat part is designed as a nozzle body which is separate from the valve housing and which is provided with the injection orifices and with the valve seat for the injection valve member. This nozzle body is fastened to the housing by means of a welded joint. Since the nozzle body consists of a different, as a rule more wear-resistant material from that of the housing, problems during welding may arise on account of the different material properties. Moreover, the welded joint is subjected to very high stress, on the one hand, due to the high system pressure prevailing in the fuel injection valve and, on the other hand, owing to the impingement of the injection valve member onto the nozzle body during closing. The quality of the welded joint therefore has to satisfy very stringent requirements.

The injection valve member of the fuel injection valves described in the abovementioned WO-A-02/086309 is likewise exposed to high mechanical stresses at its end facing the valve seat part or nozzle body, specifically for the same reasons as those mentioned above in connection with the valve seat part or the nozzle body. This, above all, when the nozzle body consists of a more wear-resistant material than the injection valve member.

### SUMMARY OF THE INVENTION

One object of the present invention is to connect a nozzle body of a fuel injection valve to the housing of said fuel injection valve in a simple and reliable way.

This object is achieved by way of a fuel injection valve as recited in the claims.

The valve seat part, provided on its outside with a conical seat surface can be brought to bear from inside the housing against the likewise conical bearing surface on the housing. As a result of the self-locking configuration of the seat surface and the bearing surface, the valve seat part is held firmly and sealingly in the housing.

Another object of the present invention is to allow for a simple and cost-effective manufacturing of a fuel injection valve.

This object is achieved by means of a method for producing a fuel injection valve as recited in the method claims.

Preferred embodiments of the fuel injection valve and the method according to the invention are claimed in the dependent claims.

Other exemplary embodiments and advantages of the present invention may be ascertained by reviewing the present disclosure and the purely diagrammatic accompanying Figures.

### BRIEF DESCRIPTION OF THE DRAWINGS

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1 shows the lower part of a fuel injection valve in longitudinal section;

FIG. 2 shows the region of the lower end of a second embodiment of a fuel injection valve on a larger scale, as compared with FIG. 1, and in longitudinal section;

FIGS. 3 and 4 show in each case the end region of alternative embodiments of an injection valve member in longitudinal section;

FIG. 5 shows the region of the lower end of a third embodiment of a fuel injection valve in an illustration corresponding to FIG. 2; and

FIG. 6 shows a fourth embodiment of a fuel injection valve in an illustration corresponding to FIG. 1.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

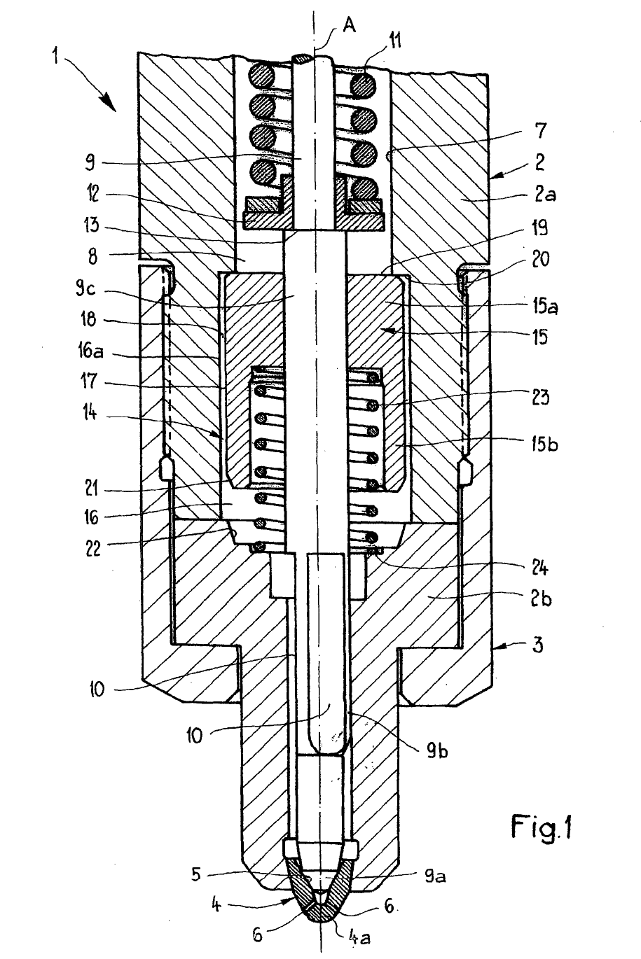

The fuel injection valve 1, which is illustrated diagrammatically in FIG. 1 and only the lower part of which is shown, has a housing 2 which is formed by an upper housing part, not illustrated, a lower housing part 2a and a valve seat element 2b. The valve seat element 2b is connected sealingly to the lower housing part 2a by means of a holding element 3 designed as a tension nut.

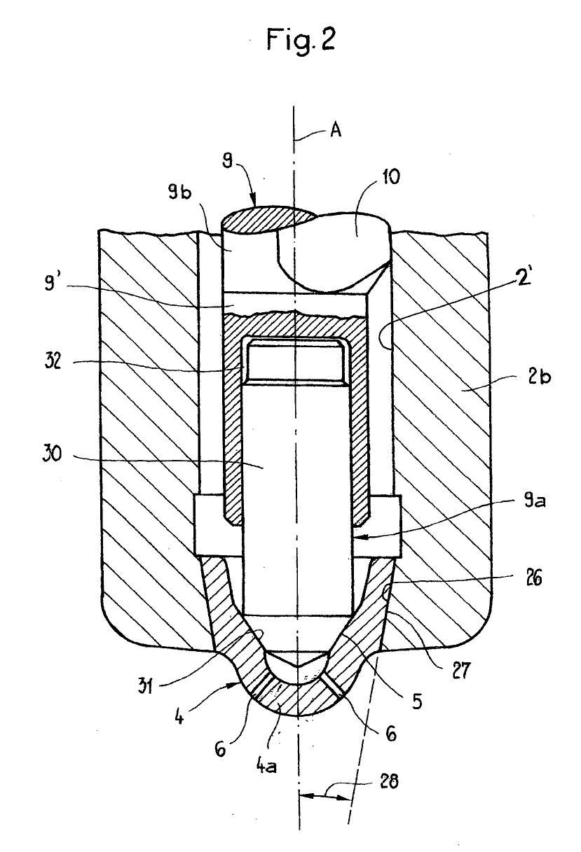

In the valve seat element 2b, a valve seat part 4 is held, which is designed as a nozzle body 4a separate from the valve seat element 2b and which has a valve seat 5 and injection orifices 6. The valve seat part 4 may, under certain circumstances, even be produced in one piece with the valve seat element 2b, as shown, for example, in FIGS. 1 and 2 of the already mentioned WO-A-02/086309. Inside the housing 2 is formed a central bore 7 which is coaxial with respect to the longitudinal axis A of the housing 2 and has a diameter changing over its length and which defines a high-pressure space 8. This high-pressure space 8 is connected in a way not shown to a high-pressure fuel inlet and extends as far as the valve seat 5.

Inside the housing 2, that is to say in the bore 7, an injection valve member 9 is arranged, which is designed as a valve needle and is coaxial with respect to the longitudinal axis A of the housing 2 and which, in the closing position shown in FIG. 1, cooperates by means of its tip 9a with the valve seat 5, in order to close the injection orifices 6. To open the injection orifices 6, the injection valve member 9 is lifted off from the valve seat 5 by means of a control device, not illustrated. The injection valve member 9 is guided in the valve seat element 2b with a close sliding fit by means of a guide part 9b. To ensure a hydraulic connection in the region of this guide of the injection valve member 9, its guide part 9b is provided with ground-down surfaces 10. The injection valve member 9 is pressed downward in a closing direction of the injection valve member 9 by means of a closing spring 11. The closing spring 11 is supported, at its end shown in FIG. 1, on a supporting ring 12 which lies on a shoulder 13 on the injection valve member 9. At the other end, not shown, the closing spring 11 is supported fixedly with respect to the housing.

Thus far, and with the exception of the mounting of the valve seat part 4 in the valve seat element 2b, the fuel injection valve 1 illustrated in FIG. 1 corresponds to the fuel injection valves which are shown and described in WO-A-02/086309 already mentioned earlier. For this reason, reference is made to this WO-A-02/086309 for a detailed explanation of the construction and type of action of the fuel injection valve 1.

In contrast to the abovementioned known fuel injection valves, the fuel injection valve 1 according to FIG. 1 has a throughflow-quantity limiting valve 14 arranged inside the high-pressure space 8. The throughflow-quantity limiting valve 14 includes a valve body 15 which is coaxial with respect to the longitudinal axis A of the housing and which is accommodated in a valve chamber 16 forming part of the high-pressure space 8. The valve body 15 has a U-shaped cross section and consists of a cylindrical bottom part 15a and of an annular part 15b which is coaxial with respect to the bottom part 15a and is open toward the valve seat 5. The valve body 15 is guided with its bottom part 15a with a close sliding fit by a guide portion 9c of the injection valve member 9. The bottom part 15a is acted upon by the fuel pressure prevailing in the high-pressure space 8. The wall 16a of the valve chamber 16 and the outer surface area 17 of the valve body 15 form an annular gap 18, the width of which preferably amounts to 0.03-0.2 mm. The valve body 15 is adjustable between an open position (upper end position) and a closing position (lower end position). In the open position, the valve body 15 bears with its end face 19 against an annular stop face 20 which is formed in the lower housing part 2a. At the end opposite this end face 19, the valve body 15 is provided with a conical sealing surface 21 which, in the closing position of the valve body 15, cooperates with a likewise conical seat surface 22 in the valve seat element 2b. Both the sealing surface 21 and the seat surface 22 are formed by portions of enveloping surfaces of circular cones which have approximately the same apex angle. However, the sealing surface 21 and the seat surface 22 may also be designed as planar surfaces which run at right angles with respect to the longitudinal axis A of the housing 2. The valve body 15 is loaded by a spring element 23 acting in the opening direction and designed as a compression spring. This spring element 23 runs inside the annular part 15b and is supported on the bottom part 15a of the valve body 15. The spring element 23 is supported at the other end on a supporting surface 24 which is formed in the valve seat element 2b.

The type of action of the throughflow-quantity limiting valve 14 is similar to the type of action, described in DE-A-43 44 190, of the shut-off valves which are shown there.

In the normal operating state between the injection operations, the valve body 15 assumes its open position. When, during an injection operation, the injection orifices 6 are opened by the injection valve member 9 being lifted off from the valve seat 5, a pressure drop occurs on the injection side, which brings about a movement of the valve body 15, acted upon on its end face 19 by the high operating pressure, out of the open position toward the closing position counter to the force of the spring element 23. In this case, however, the valve body 15 does not move into its closing position. At the end of the injection operation as a result of the closing of the injection orifices 6 by the injection valve member 9, the valve body 15 comes to a standstill in an intermediate position between its open position and its closing position. In this intermediate position, fuel afterflows via the annular gap 18. On account of the pressure rising again on that side of the valve body 15 which faces the valve seat part 4, and under the action of the spring element 23, the valve body 15 moves back into its open position again.

If, however, as a result of a fault, the injection valve member 9 remains in its open position and therefore the pressure drop on the injection side persists, the valve body 15 moves into its closing position, in which it bears with its sealing surface 21 against the seat surface 22. In this closing position, the throughflow of fuel to the valve seat 5 is thus interrupted. This means that only fuel quantity which can flow through the narrow guide between the guide portion 9c of the injection valve member 9 and the valve body 15 (leakage quantity) can afterflow into the combustion space of the corresponding cylinder. This leakage quantity is only very small, however, on account of the configuration of this guide between the valve body 15 and the injection valve member 9 as a close sliding fit. In the event of damage, therefore, at best, combustion under part load can occur in the affected cylinder.

As already mentioned, both the sealing surface 21 on the valve body 15 and the seat surface 22 on the valve seat element 2b are designed as portions of enveloping surfaces of circular cones, the apex angles of which are designed in such a way that a selflocking action occurs when the valve body 15 is in the closing position. For this purpose, these circular cones have an apex half angle of 2°-7°. The result of this selflocking action is that, with the engine stopped, that is to say in the absence of feed pressure, the valve body 15 does not lift off automatically from the seat surface 22. Consequently, in the event of a defective fuel inlet valve 1, even when the engine is restarted, no fuel can pass into the cylinder combustion space (with the exception of the small leakage quantity which can flow through the close sliding fit between the valve body 15 and the injection valve member 9).

The annular part 15b of the valve body 15 has a relatively large wall thickness. If, then, the valve body 15 is in its closing position and the high fuel pressure (for example 2000 bar and above) prevails in the high-pressure space 8, upstream of the seat surface 22, that is to say also in the annular gap 18, then the annular part 15b is compressed in the radial direction. When the feed pressure falls, the annular part 15b expands again, thus resulting in a clamping of the valve body 15 against the conical seat surface 22.

An engine having a fuel injection valve 1 with an integrated throughflow-quantity limiting valve 14 can thus be stopped and restarted, without a defective fuel injection valve 1 leading to engine overload. The engine thus has emergency running properties, even after a stop.

As already mentioned, in the intermediate positions of the valve body 15, the annular gap 18 forms a fuel throughflow connection. Such a connection may also take place in another way, for example by means of at least one longitudinal groove, extending in the direction of the longitudinal axis A of the housing 2, on the outside of the valve body 15 or in the wall 16a of the valve chamber.

The valve body 15 may also have a cross-sectional form other than that shown and, for example, have a T-shaped cross section. In such a cross-sectional form, contrary to what is shown in FIG. 1, the annular part adjoining the bottom part 15a has a smaller diameter than the bottom part 15a and is guided in the same way as the bottom part 15a by the guide portion 9c of the injection valve member 9. In this variant, therefore, the valve body 15 has a guide bore which passes both through the bottom part 15a and through the annular part and through which the injection valve member 9 runs with a close sliding fit. The spring element 23 supported on the bottom part 15a and on the supporting surface 24 then surrounds the annular part. In this embodiment of the valve body 15, the abovementioned fuel throughflow connection may also be formed by a passage in the valve body 15 itself. In this alternative embodiment, the passage of leakage liquid through the close sliding fit is prevented, because, in the closing position of the valve body 15, the annular part of the valve body 15 is deformed both under the high pressure acting on its cylindrical outer surface and due to the radially acting force of the conical surfaces 21 and 22 wedged one in the other and is pressed against the injection valve member 9. Moreover, in this variant, the valve body 15 may be designed with a smaller diameter, so that the wall thickness of the lower housing part 2a can be greater and the wall of the latter can be more pressure-resistant.

As already mentioned, the valve seat part 4 held in the valve seat element 2b is designed as a nozzle body 4a separate from the valve seat element 2b. With reference to FIG. 2, then, which shows the injection-side end of the fuel injection valve 1 on an enlarged scale, the way in which this valve seat part 4 or nozzle body 4a is held in the valve seat element 2b is explained in more detail.

As is known from WO-A-02/086309 already mentioned earlier (see, for example, FIG. 13), the nozzle body 4a is produced from a substantially harder material than the housing 2 of the fuel injection valve 1, in order to keep the wear lower and consequently to prolong the useful life of the fuel injection valve 1. Since the material used for producing the nozzle body 4a is very costly, the nozzle body 4a is of very small design for cost reasons.

The nozzle body 4a has on its outside a conical seat surface 26 which is formed by a portion of the enveloping surface of a straight circular cone, the axis of which coincides with the longitudinal axis A of the housing 2. The nozzle body 4a bears with this seat surface 26 against a likewise conical bearing surface 27 which is formed in the valve seat element 2b. This bearing surface 27 is likewise formed by a portion of the enveloping surface of a straight circular cone, the axis of which coincides with the longitudinal axis A of the housing 2. The apex half angles 28 of the two circular cones forming the seat surface 26 and the bearing surface 27 are selected such that the nozzle body 4a is held selflockingly and sealingly in the valve seat element 2b. These apex half angles 28 amount to 2°-7°.

As may be gathered from FIG. 2, during mounting, the nozzle body 4a is inserted into the valve seat element 2b from above.

During the production of the nozzle body 4a, both the valve seat 5 and the seat surface 26 are formed in the same chucking of the nozzle body 4a by grinding. A guide surface 2′ for guiding the guide part 9b of the injection valve member 9 and the bearing surface 27 are likewise ground on the valve seat element 2b in the same chucking of the valve seat element 2b. For this purpose, the grinding tool (grinding mandrel) is preferably introduced into the valve seat element 2b from the side of the bearing surface 27.

In a variant, not shown, of the fuel injection valve 1 shown in FIG. 1, the seat surface 22 is located in the lower housing part 2a. In this case, the valve body 15 is built into the housing 2 from above. The stop face 20 and the holding element 3 are dispensed with. In order to define the open position of the valve body 15, after the mounting of the valve body 15 a stop element, for example a spring ring or securing ring (Seeger ring or the like) may be built into the housing part 2a. Alternatively, the end face 19 of the valve body 15 could be supported on the underside of the supporting ring 12. The force of the spring element 23 would then be conducted further on upward to the supporting ring 12. As a result, the force of the closing spring 11 acting in the closing direction of the injection valve member 9 would decrease before the commencement of an injection operation, and, in some cases, this may be advantageous.

In the variant described above, the housing part 2a and the valve seat element 2b may also be produced in one piece and form part of the housing 2. In this case, the tension nut 3, as mentioned, may be dispensed with. In this instance, the machining of the guide surface 2′ and of the bearing surface 27 from the side of the bearing surface 27 is particularly advantageous.

It is also possible for the nozzle body 4a to be designed according to the invention, as described, in the case of fuel injection valves in which the supply of fuel to the valve seat 5 takes place via a supply duct offset laterally with respect to the longitudinal axis A of the housing 2 (instead of via the central high-pressure space 8, as shown).

As explained above, the valve seat part 4 designed as a separate nozzle body 4a is produced from a more wear-resistant (harder) material than the housing 2, thus entailing a prolongation of the useful life of the valve seat part 4. With reference to FIGS. 2-5, then, embodiments of fuel injection valves are shown, in which the useful life of the injection valve member 9 is also prolonged.

In the exemplary embodiments shown in FIGS. 2-5, the tip 9a of the injection valve member 9 is formed by an insert part 30 which is connected or coupled, for joint movement, to the contiguous portion 9′ of the injection valve member 9 and which has a sealing surface 31 coming to bear against the conical valve seat 5. The insert part 30 consists of a harder, more wear-resistant, but also more costly material than the remaining part of the injection valve member 9. The aim, therefore, is to keep this insert part 30 as small as possible.

In the embodiment according to FIG. 2, the insert part 30 has a cylindrical form and engages into a bore 32 in the contiguous portion 9′ of the injection valve member 9. So that the insert part 30 can be exchanged, as required, it is held in the orifice 32 with a press fit.

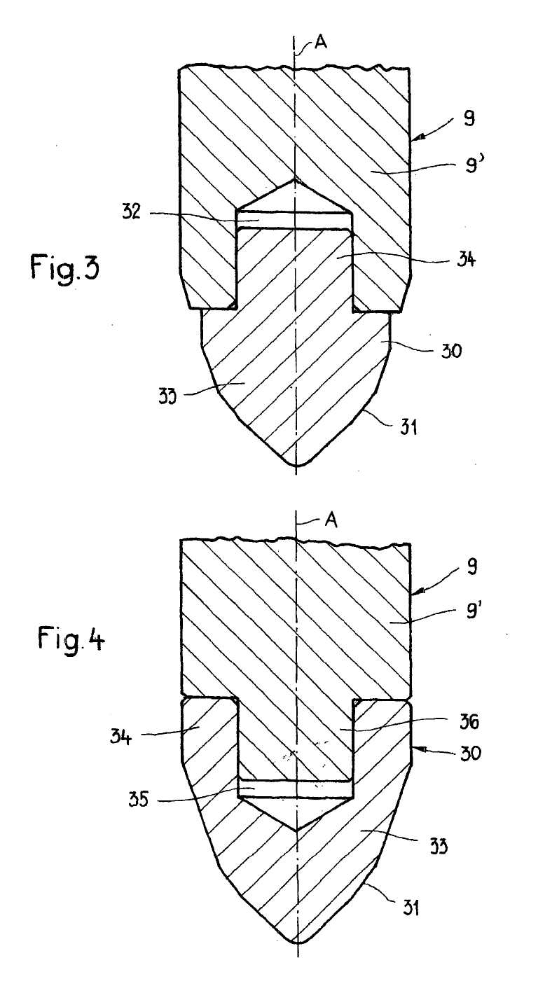

In the variant shown in FIG. 3, the insert part 30 has smaller dimensions than the insert part 30 according to FIG. 2 and has a sealing body 33 and a holding part 34 of smaller diameter which is in one piece with the sealing body 33. The sealing body 33 is provided with the sealing surface 31 and projects beyond the contiguous region 9′ of the injection valve member 9, while the holding part 34 engages into the bore 32 in this contiguous portion 9′ of the injection valve member 9 and is held with a press fit in this orifice.

In the embodiment shown in FIG. 4, the holding part 34, likewise in one piece with the sealing body 33, is provided with a recess 35, into which an extension 36 on the contiguous portion 9′ of the injection valve member 9 engages. The insert part 30 is held on the extension 36, specifically likewise by means of a press fit.

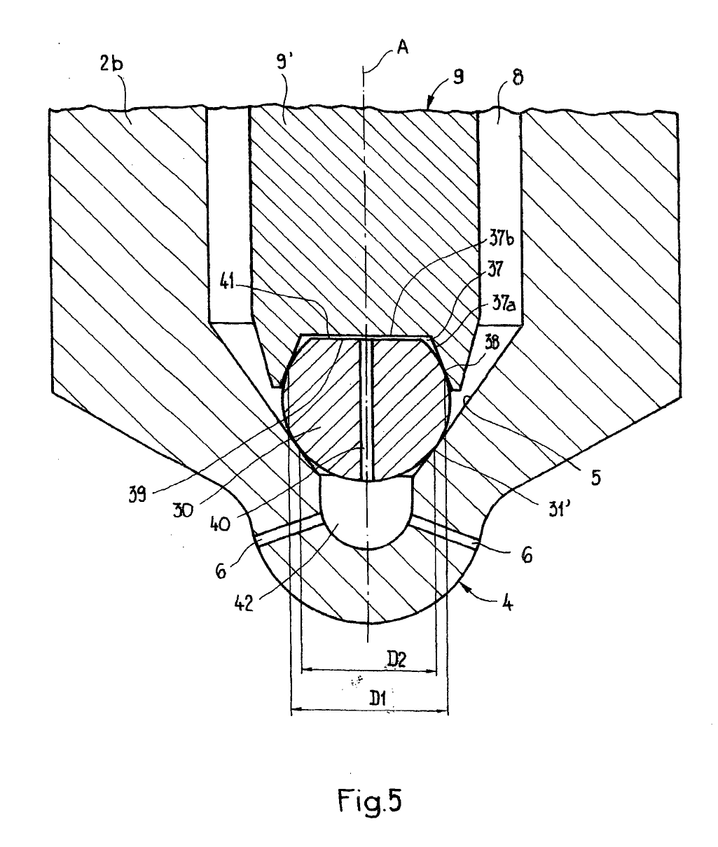

FIG. 5 shows an embodiment in which the insert part 30 is designed as a spherical body which engages into a recess 37 in the contiguous portion 9′ of the injection valve member 9. The side wall 37a of the recess 37 is formed by a portion of the enveloping surface of a straight circular cone, the axis of which coincides with the longitudinal axis A of the housing 2. The insert part 30 bears with an essentially linear bearing surface 38 against the side wall 37a of the recess 37, said side wall diverging toward the valve seat 5. The diameter of this bearing surface 38 is designated by D1. On the side facing the base 37a of the recess 37, the insert part 30 is provided with a planar surface 39 which lies opposite this base 37b. The insert part 30 is thereby prevented from rotating in the recess 37. Furthermore, the insert part 30 is provided with a throughbore 40 which is coaxial with respect to the longitudinal axis A of the housing 2 and which connects the space 41 between the base 37b of the recess 37 and the planar surface 39 of the insert part 30 to a space 42 which, as seen in the direction of flow of the fuel, lies downstream of the valve seat 5 and is connected to the combustion space of the engine via the injection orifices 6.

The spherical insert part 30 has an essentially linear sealing surface 31′, the diameter of which is designated by D2. This diameter D2 is smaller than the diameter D1 of the bearing surface 38 with which the insert part 30 bears against the wall 37a of the recess 37.

The insert part 30 lies loosely in the recess 37, that is to say it is not connected fixedly to the contiguous portion 9′ of the injection valve member 9. When the injection valve member 9 is being lifted off away from the valve seat 5 in order to open the injection orifices 6, the insert part 30 follows the contiguous portion 9′ of the injection valve member 9, specifically for the following reasons: with the injection valve member 9 located in the closing position (as illustrated in FIG. 5), the pressure in the space 41 is much lower than the system or operating pressure. On account of this pressure difference and of said differences in the diameters D1 and D2, the insert part 30 is pressed into the recess 37 and is thus pressed onto the contiguous portion 9′ of the injection valve member 9.

It goes without saying that the tip 9a of the injection valve member 9 may be designed as a separate insert part 30 even when the fuel valve 1 is not designed with a throughflow limiting valve 14, and irrespective of whether the valve seat part 4 is designed as a nozzle body 4a separate from the housing 2 and/or from the valve seat element 2b or is in one piece with the housing 2.

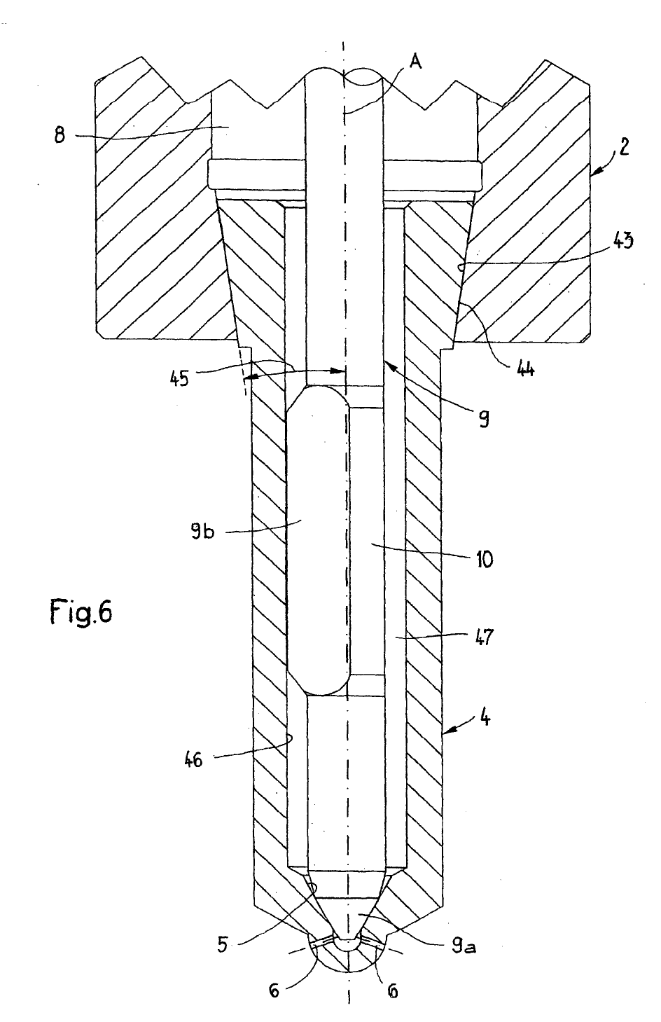

FIG. 6 illustrates diagrammatically the lower part of a fourth embodiment of a fuel injection valve 1, and, for those parts which correspond to parts of the embodiments shown in FIGS. 1 and 2, the same reference symbols are used in this FIG. 6 as in FIGS. 1 and 2.

In the embodiment according to FIG. 6, the valve seat part 4 is held in the housing 2. For this purpose, the valve seat part 4 has on its outside, at its end lying opposite the valve seat 5, a conical seat surface 43 which is formed by a portion of the enveloping surface of a straight circular cone, the axis of which coincides with the longitudinal axis A of the housing 2. The valve seat part 4 bears with this seat surface 43 against a likewise conical bearing surface 44 which is formed in the housing 2. This bearing surface 44 is likewise formed by a portion of the enveloping surface of a straight circular cone, the axis of which coincides with the longitudinal axis A of the housing 2. The apex half angles 45 of the two circular cones forming the seat surface 43 and the bearing surface 44 are selected such that the valve seat part 4 is held selflockingly and sealingly in the housing 2. These apex half angles 45 amount to 2°-7°.

The valve seat part 4, like the nozzle body 4a of the embodiments according to FIGS. 1 and 2, is produced from a substantially harder material than the housing 2 of the fuel injection valve 1, in order to keep the wear lower and consequently to prolong the useful life of the fuel injection valve 1.

During mounting, the valve seat part 4 is inserted into the housing 2 from above.

The valve seat part 4 is designed as an elongate component and has an outside diameter which is smaller than the outside diameter of the housing 2. In the embodiment according to FIG. 6, therefore, the outside diameter of the lower end of the fuel injection valve 1 is smaller than in the embodiment according to FIGS. 1 and 2.

In the embodiment shown in FIG. 6, the injection valve member 9 is guided in the valve seat part 4. The wall 46 of the inner bore 47 of the valve seat part 4 is correspondingly designed as a guide surface for the guide part 9b of the injection valve member 9.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A fuel injection valve for the intermittent injection of fuel into the combustion space of internal combustion engines, with an elongated housing, with a valve seat part which has a valve seat provided with injection openings, with a longitudinally displaceable injection valve member which is arranged in the housing and which cooperates with the valve seat for closing and opening the injection openings, and with a control device for controlling the displacement movement of the injection valve member, wherein the valve seat part is provided on its outside with a seat surface which is formed by the enveloping surface of a circular cone and with which said valve seat part bears against a bearing surface, likewise formed by the enveloping surface of a circular cone, on the housing, the apex half angles of the circular cones defining the seat surface and the bearing surface being selected such that the valve seat part is held self-lockingly and sealingly in the housing.

2. The fuel injection valve as claimed in claim 1, wherein the valve seat part is designed as a nozzle body separate from the housing and connected to the housing.

3. The fuel injection valve as claimed in claim 1, wherein the apex half angles amount to 2°-7°.

4. The fuel injection valve as claimed in claim 3, wherein the apex half angles are equal.

5. The fuel injection valve as claimed in claim 1, wherein the injection valve member is arranged in a high-pressure space which runs coaxially with respect to the longitudinal axis of the housing and which is connected to a high-pressure fuel inlet and extends as far as the valve seat.

6. The fuel injection valve as claimed in claim 1, wherein the elongated valve seat part has an inner bore, the wall of which is designed as a guide for the injection valve member.

7. The fuel injection valve as claimed in claim 1, wherein the valve seat part comprises a more wear-resistant material than the housing.

8. A method for producing the fuel injection valve as claimed in claim 1, wherein both, the bearing surface on the housing and a guide surface for the injection valve member are formed in the same chucking of the housing.

9. The method as claimed in claim 8, wherein the machining of the bearing surface and of the guide surface takes place by way of a tool which is introduced into the housing from the side having the bearing surface.

10. A method for producing a fuel injection valve used for the intermittent injection of fuel into the combustion space of internal combustion engines, said fuel injection device comprising an elongated housing, a valve seat part which has a valve seat provided with injection openings and which is provided with a seat surface with which said valve seat part bears against a bearing surface on the housing, a longitudinally displaceable injection valve member which is arranged in the housing and which cooperates with the valve seat for closing and opening the injection openings, and a control device for controlling the displacement movement of the injection valve member, wherein both, the bearing surface on the housing and a guide surface for the injection valve member are formed in the same chucking of the housing.

11. The method as claimed in claim 10, wherein the machining of the bearing surface and of the guide surface takes place by way of a tool which is introduced into the housing from the side having the bearing surface.

12. The method as claimed in claim 10, wherein the bearing surface on the housing is formed by the enveloping surface of a circular cone.
